(19) United States
(12) Patent Application Publication
(10) Pub. No.: US 2008/0215684 A1
(43) Pub. Date: Sep. 4, 2008

(54) Wireless E-Mail System and Method for Using Same

(75) Inventors: Haraldur Thorkelsson, Montreal (CA); Leonard D'cunha, Montreal (CA); Teresa Hunkeler, Montreal (CA); Sylvain Legault, Pierrefonds (CA); Vaclav Mares, Montreal (CA); Steve Menard, Montreal (CA)

Correspondence Address: COATS & BENNETT/OZ, 1400 CRESCENT GREEN, SUITE 300, CARY, NC, 27518, US

(73) Assignee: OZ Communications

(21) Appl. No.: 10/579,610

(22) PCT Filed: Jan. 24, 2006
(86) PCT No.: PCT/CA06/00086

§ 371 Date: May 17, 2006

Related U.S. Application Data
(60) Provisional application No. 60/645,614, filed on Jan. 24, 2005.

(30) Foreign Application Priority Data
Jan. 24, 2005 (CA) 2,493,907

(51) Int. Cl. G06F 15/16

(52) U.S. Cl. 709/206

(57) ABSTRACT

A wireless e-mail system and method is disclosed. The system comprises a wireless mobile device comprising an e-mail client, an e-mail server, a gateway, a mobile network interconnecting the wireless mobile device and the gateway, and a broadband network interconnecting the gateway and the e-mail server. When the client transmits a single self-contained request to the gateway via the mobile network to retrieve a set of e-mail related information from the e-mail server, the gateway retrieves at least the e-mail related information from the e-mail server via the broadband network using a plurality of transactions, compiles the retrieved information into a single self contained response and transmits the single response via the mobile network to the e-mail client.

### FIELD OF THE INVENTION

The present invention relates to a wireless e-mail system and method for using same. In particular the present invention relates to an e-mail system comprised of an e-mail client which communicates with one or more e-mail servers via a gateway.

### BACKGROUND

As known in the art, e-mail systems typically store e-mail messages on an e-mail server in mail boxes associated with a particular e-mail address or user. Internet Message Access Protocol (IMAP) and Post Office Protocol Version 3 (POP3) are well known standardised client/server protocols designed to operate over TCP/IP. Additionally, a variety of proprietary protocols, such as MSN Hotmail®, etc. are also known in the art for doing the same. These protocols allow Mail User Agents (MUAs) or e-mail clients to examine, manipulate and retrieve e-mail messages stored in mail boxes on an e-mail server. However, although the way in which these protocols are used to manipulate the e-mail messages stored on their respective e-mail servers is well defined, the way in which the e-mail messages are retrieved and displayed to the user is non-standardised. In particular, the sequence of transactions or commands defined in the protocols and which must be exchanged between MUA and e-mail server in order to effect a transfer of message related data, as well as the content and user interface which is presented to the user, are not standardised. In order to present the content to the end-user via standard protocols such as IMAP and POP3, or via proprietary protocols such as Hotmail's MSP, the MUA or client must retrieve the message related data from the e-mail server, and process the data to present it in the desired format. As these protocols were typically designed for use over broadband networks, they are very chatty and as a result, examining, manipulating and retrieving e-mail messages stored in mail boxes on an e-mail server typically requires a significant number of transactions, processing and memory usage on the part of the e-mail client.

POP3, for example, and as described in RFC 1939 the entire contents of which is incorporated herein by reference, provides a limited command set allowing an e-mail client to download a simple list (limited to a reference number and the size of the e-mail in octets) of e-mail messages stored in a mail box on the server, download messages individually using the reference number, or delete a message using the reference number. However, in order for the e-mail client to present a list of e-mails to a user, for example via a display screen or the like, the e-mail client must first download the messages, extract particular fields from the messages (for example the sender and subject) and compile these into a suitable page of information for display to the user.

IMAP, on the other hand and as described in RFC 3501 the entire contents of which is incorporated herein by reference, presents a much richer command set. For example, the FETCH command may be used to retrieve only portions of a series of messages, such as the headers, flags, etc., without requiring the entire messages to be downloaded. As a result, the MUA can be more selective at the outset in determining message related data to be retrieved from the IMAP server, thereby reducing somewhat, at least at an initial step, the amount of data which must be transferred between server and MUA.

IMAP and POP3 compatible e-mail clients are already implemented on a number of wireless mobile devices, allowing these wireless mobile devices to retrieve, transmit and otherwise manipulate e-mail message through direct interaction with the e-mail server. Additionally, web-portal based e-mail, such as that provided by Yahoo! and Hotmail, are also available on wireless mobile devices using Wireless Application Protocol (WAP) browsers. However, the use of chatty e-mail protocols (such as IMAP, POP3, Simple Message Transfer Protocol (SMTP) or other proprietary e-mail protocols) with clients implemented on wireless mobile devices to interface directly with an e-mail server results in a number of significant drawbacks. In particular, as such wireless devices are typically constrained by memory size, processing capabilities as well as the speed of any data interconnection, interfacing directly with such e-mail servers results in high latencies, increased battery consumption and large memory requirements. Furthermore, cellular wireless networks typically impose that radio channels be assigned to the wireless mobile devices for data transactions, rather than to make use of random access channels, which consumes network capacity. In addition, the above channel assignment process takes time, which also adds to latency. Ideally, a minimum amount of channel assignments should be made.

One additional drawback with implementing a e-mail client on wireless mobile devices which communicates directly with the e-mail server is that data traffic related to examining, manipulating or retrieving e-mail messages stored in mail boxes on an e-mail server appears in the mobile network simply as data traffic, and is not distinguishable from other types of data traffic, such as for example data traffic related to web browsing or the like. As a result, mobile operators are typically unable to monitor the usage or to provide specific subscriptions based on such e-mail services.

The above drawbacks are in part a consequence of the design of the described e-mail protocols, which were conceived primarily for use over broadband networks where latency is low, bandwidth relatively cheap and network availability high. Furthermore, IMAP and POP3 amongst other e-mail protocols have been designed to expect the use of a relatively powerful smart (thick) e-mail client (such as that available on a PC) which is able to cope with large amounts of complex data which, given the limited resources, are not readily available with most wireless mobile devices.

### SUMMARY OF THE INVENTION

In order to address the above and other drawbacks there is provided a wireless e-mail system. The system comprises a wireless mobile device comprising an e-mail client, an e-mail server, a gateway, a wireless network interconnecting the wireless mobile device and the gateway, and a broadband network interconnecting the gateway and the e-mail server. When the client transmits a single self-contained request to the gateway via the wireless network to retrieve a set of e-mail related information from the e-mail server, the gateway retrieves at least the e-mail related information from the e-mail server via the broadband network using a plurality of transactions, compiles the retrieved information into a single self contained response and transmits the single response via the wireless network to the e-mail client.

Additionally, there is disclosed a gateway interconnecting a wireless mobile device and an e-mail server, the wireless mobile device comprising an e-mail client and adapted for data communication with a wireless network, the e-mail server adapted for data communication with a broadband network. The gateway comprises a first stateless interface interconnected with the wireless network, a second interface interconnected with the broadband network, and a channel management function. When the e-mail client transmits a single self-contained request to the first interface via the wireless network to retrieve a set of e-mail related information from the e-mail server, the channel management function retrieves at least the e-mail related information from the e-mail server via the second interface and the broadband network using a plurality of transactions, compiles the retrieved information into a single self contained response and transmits the single response via the first interface and the mobile network to the e-mail client.

There is also disclosed a method for retrieving e-mail related information from an e-mail server via a communications system comprising a wireless network and a broad band network. The method comprises the steps of, in a client e-mail application, forming a single request for the e-mail related information, transmitting the single request to a gateway via the wireless. network, the gateway downloading at least the e-mail related information from the server via the broadband network using a plurality of transactions. The gateway compiles the retrieved information into a single response, transmitting the single response to the client application via the wireless network, and in the client application, retrieving the e-mail related information from the response.

Furthermore, there is disclosed a method for retrieving e-mail related information from an e-mail server via a communications system comprising a wireless network and a broad band network. The method comprises the steps of providing an e-mail gateway comprising a first stateless interface interconnected with the wireless network and a second interface interconnected with the broadband network, in a client e-mail application, transferring a single request for the e-mail related information to the first interface via the wireless network, in the gateway receiving the request at the first interface, retrieving at least the requested e-mail related information from the server via the broadband network using a plurality of transactions; compiling the retrieved information into a single response and transmitting the single response to the client application via the first interface and the wireless network and in the client application, retrieving the e-mail related information from the response.

Also, there is disclosed a method for logging e-mail data traffic between at least one wireless mobile device comprising a client e-mail application and an e-mail server interconnected by a wireless mobile operator network and a broadband network, the mobile network comprised of a wireless network and a ground network, the wireless network interconnecting the at least one wireless mobile device and the ground network and wherein the e-mail data traffic comprises at least one request for e-mail related information generated by the client e-mail application. The method comprises the steps of providing an e-mail gateway between the ground network and the broadband network, for each request generated by the client e-mail application, transferring the request to the gateway via the wireless network, in the gateway receiving each request, logging each received request, retrieving at least the requested e-mail related information from the e-mail server, compiling the retrieved information into a single response, logging the single response and transmitting the single response to the client application via the wireless network.

Other objects, advantages and features of the present invention will become more apparent upon reading of the following non-restrictive description of illustrative embodiments thereof, given by way of example only with reference to the accompanying drawings.

### BRIEF DESCRIPTION OF THE DRAWINGS

Reference will now be made to the accompanying drawings, showing by way of illustration an illustrative embodiment of the present invention, and in which:

FIG. 1A schematically illustrates a wireless e-mail system in accordance with an illustrative embodiment of the present invention;

FIG. 1B schematically illustrates a wireless e-mail system in accordance with an alternative illustrative embodiment of the present invention;

FIG. 2 provides a front plan view of a wireless mobile device in accordance with an illustrative embodiment of the present invention;

FIGS. 3A through 3C provide illustrative embodiments of screen displays on a wireless mobile device

FIG. 4 schematically illustrates the communication interfaces employed in the wireless e-mail systems of FIGS. 1A and 1B;

FIG. 5 presents a block diagram providing a functional overview of the E-mail Gateway of FIGS. 1A and 1B in accordance with an illustrative embodiment of the present invention;

FIG. 6 presents a flow chart of a high-level sequence of events of a single wireless e-mail transaction between an end user, an e-mail gateway and an e-mail server in accordance with an illustrative embodiment of the present invention;

FIG. 7A provides the transactions used to request e-mail related information from an IMAP server in accordance with an illustrative embodiment of the present invention;

FIG. 7B provides the transactions used to send e-mail via an SMTP server in accordance with an illustrative embodiment of the present invention;

FIG. 7C provides the transactions used to send a notification to the wireless mobile device e-mail in accordance with an illustrative embodiment of the present invention; and

FIG. 8 presents a flow chart of a possible implementation of an e-mail thin client in accordance with an illustrative embodiment of the present invention.

### DESCRIPTION OF THE ILLUSTRATIVE EMBODIMENTS

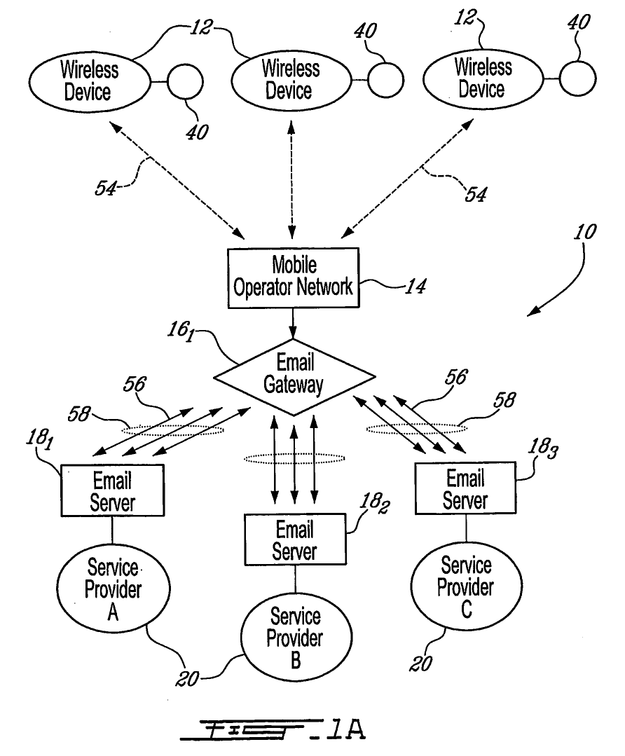

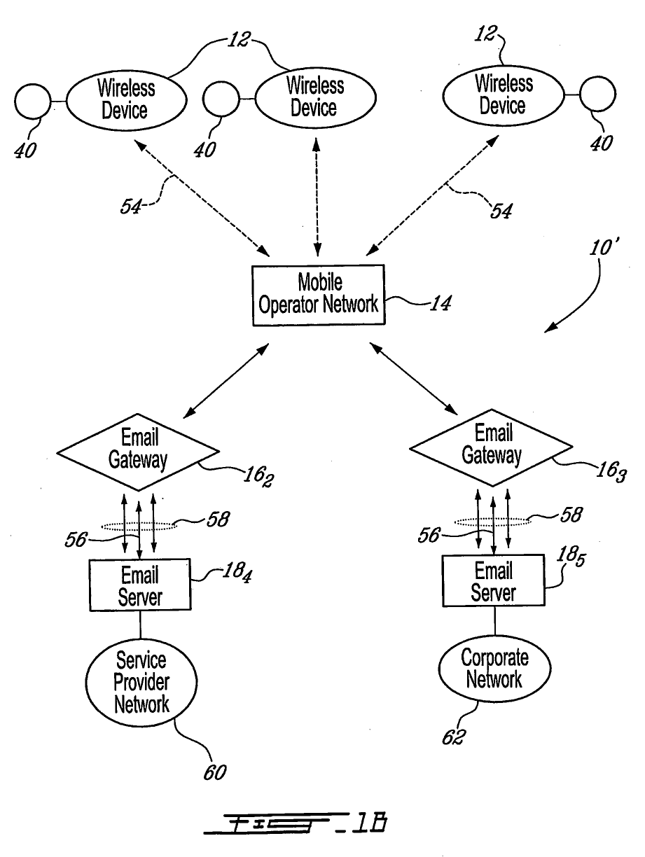

Referring now to FIG. 1A, a wireless e-mail system, generally referred to using the numeral 10, and in accordance with an illustrative embodiment of the present invention, will now be described. The wireless e-mail system 10 generally comprises the following components:
At least one end user wireless mobile device, as in 12, such as GSM mobile phones and the like, or any other wireless mobile device including palm and pocket PCs, PDAs, etc;
a mobile operator network 14 providing bi-directional wireless data communications;
an e-mail gateway 16 which has connectivity to the mobile operator network 14 and the e-mail server 18; and
at least one e-mail server, as in 18, from at least one e-mail service provider, as in 20.

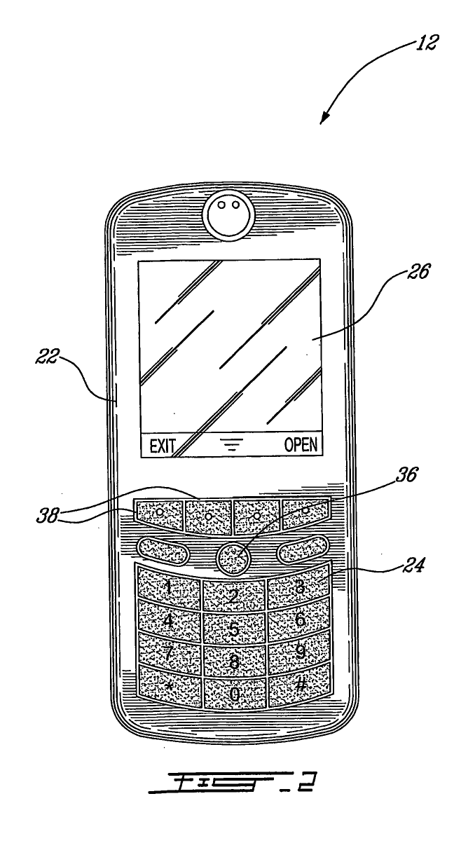

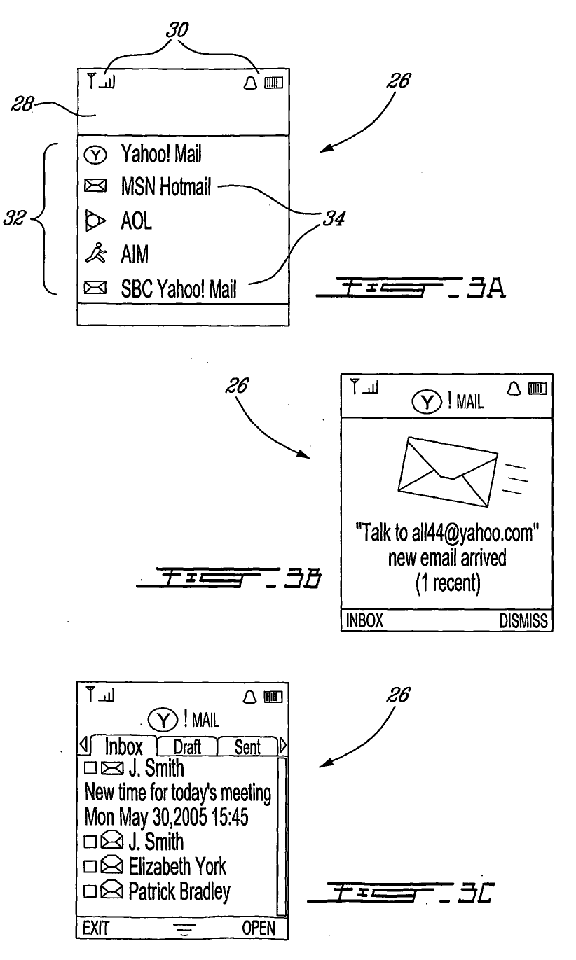

Referring to FIG. 2, each mobile device 12 generally comprises ROM, RAM, a processor and a removable/reusable battery housed within a housing 22. The mobile device 12 is further comprised of a user interface typically comprised of a keypad 24 (and may include other input means such as a voice recorder or the like) and a display 26 (colour or monochrome display or displays) for interfacing with the user and providing visual access to e-mail and other communicated and stored information. For example, referring to FIG. 3A the display 26 may be used to display banners 28, various icons as in 30 providing visual indication as to the current status of the mobile device, such as battery consumption and signal strength and the like, a menu 32 comprised of a series of user selectable entries as in 34 such as e-mail or other applications or user configurable options or the like and other user selectable fields as in 36 (for example for providing additional options used for controlling the device).

Referring now back to FIG. 2 in addition to FIG. 3A, as known in the art the user can migrate between different menus as in 32 and menu entries as in 34 using the keypad 24, scroll key 36, soft keys as in 38 or a combination of the above. Alternatively, in a particular embodiment the display 26 can be touch sensitive thereby providing for migration between menus as in 32 and menu entries as in 34 using a stylus (not shown), finger, or the like. The display 26 can also be used for displaying application specific information such as, and referring now to FIG. 3B, the arrival of new e-mail or, referring now to FIG. 3C, displaying the contents of a user's mailbox, or the like.

Referring back to FIG. 1A, the wireless mobile device 12 also comprises wireless connection capabilities, such as GSM, CDMA2000, UMTS or other such capabilities, for wirelessly connecting to and communicating with a mobile operator network 14. Furthermore, in order to support the present wireless e-mail system, each mobile device 12 implements an e-mail client application 40 typically in the form of a software program residing on each wireless mobile device 12. The primary functions of the e-mail client application 40 are to:
Interface with the end user to allow for user input and to display the requested e-mail information;
use a specific interface (Interface A of FIG. 2 further described hereinbelow) to request services from the e-mail gateway 16; and
provide a common implementation base for different user interfaces from the different e-mail service providers 20.

The e-mail client application 40 is illustratively implemented as a JAVA™ midlet which runs on a virtual JAVA machine (not shown) provided by mobile device 12. As known in the art, JAVA applications typically have access to a variety of different services, such as communications, via a JAVA Application Programming Interface (API). Illustratively, one of these services is an HTTP stack for providing communications via the mobile operator network 14, but other stacks, such as TCP or WAP, may also be provided in particular implementation.

The mobile operator network 14 is a network supporting wireless data communication based on GSM, CDMA2000, UMTS, or other such systems. The mobile operator network 14 provides the wireless data communication system (dashed lines) between the various wireless mobile devices 12 and the landline network (solid lines) connecting the various e-mail servers 18 of each service provider 20.

The e-mail service providers 20 and their respective e-mail servers 18 support standard or proprietary e-mail signalling protocols such as IMAP, POP3, Hotmail's MSP, or other such protocols for the management and retrieval of e-mail, as well as standard or proprietary signalling protocols, such as SMTP, Hotmail's MSP or other such protocols for sending e-mail. E-mail service providers may include, but are not limited to, Yahoo! Mail, AOL Mail, Hotmail, or any other common consumer-based Internet Service Provide (ISP) e-mail servers such as POP or IMAP, web-based e-mail providers or corporate e-mail providers. The e-mail servers 18 in the illustrated embodiments operate as they would with standard communications established by prior art wired and wireless devices. However, although the e-mail client application 40 may be implemented using a standard protocol (for example communicating over HTTP), its implementation will be executed in a unique way. For example, if a mail is deleted by the end user, it may or may not be required that the e-mail client application 40 move the e-mail to the “Deleted Items” folder. In this regard, the transactions used in the protocol are standard, but the sequence of the transactions and the overlying structure of the e-mail client application 40 may be unique depending on the implementation.

Illustratively, the primary functions of the e-mail gateway 16 are to offload processing and signalling for e-mail access from multiple wireless mobile devices, as in 12, onto an external platform which forms part of the wired (typically broadband) network (solid lines in FIGS. 1A, 1B, 4 and 5), and to allow the mobile network operator 16 to monitor usage of the specific e-mail services. The gateway 16 furthermore allows the wireless mobile devices 12 to implement a thin e-mail client application 40 which can still support multiple user interfaces of the different e-mail service providers 20. The main functions of the gateway 16 include:
(A) Processing requests from the e-mail client application 40 of each wireless mobile device 12;
(B) translating the standard e-mail protocols based on implementation of a specific e-mail service (e.g. HOT Mail);
(C) logging e-mail date traffic such as requests and responses for generating billing reports and billing data;
(D) logging e-mail date traffic such as requests and responses for monitoring traffic and generating traffic reports;
(E) allowing for the mobile operator to configure settings in a particular deployment or for a particular handset type.

In particular, referring to function (E) above, the gateway may contain configuration options to allow for different behaviour based on mobile operator preferences or on limitations of a specific wireless mobile device 12. The configurable options may comprise:
The number of e-mails to include per page view of mailbox (e.g. 10);
the fields to include per page view of mailbox (e.g. subject, from, date); and
the maximum size of an e-mail message to download at a time (e.g. 10 kB).

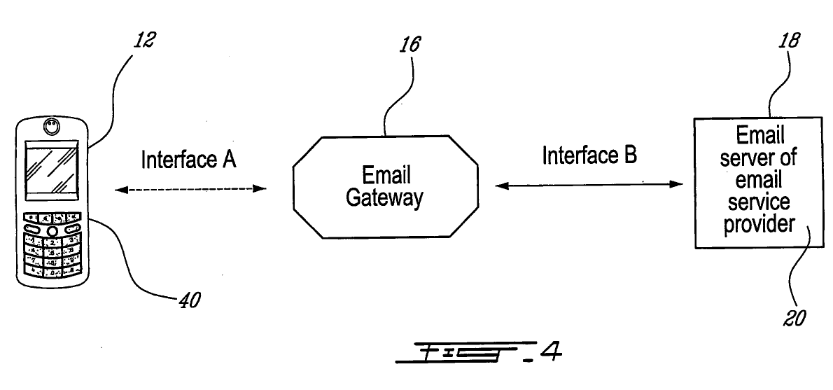

Referring now to FIG. 4, the e-mail gateway 16 generally serves as a bridge between the wireless devices 12 and the service providers 20. As will be discussed in greater detail below, the gateway 16 processes requests incoming from the e-mail client application 40 of devices 12 using a first interface, that is interface A of FIG. 4, and communicates those requests in one form or another to the e-mail servers 18 of the e-mail service providers 20 using a second interface, that is interface B of FIG. 4.

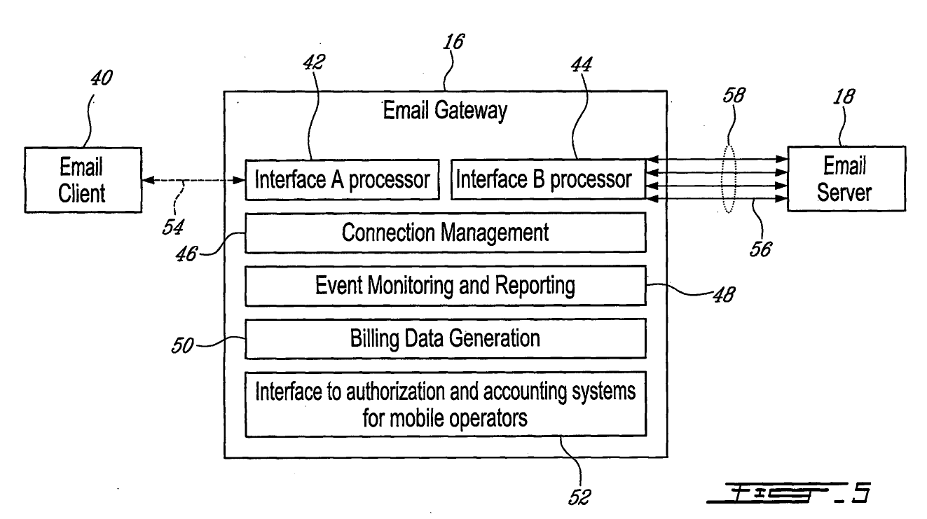

Referring now to FIG. 5, the e-mail gateway 16 is illustratively comprised of a pair of interface processors 42, 44 designated interface Processor A and interface Processor B, a connection management function 46, an event monitoring and reporting function 48, a billing data generation function 50 and an interface function 52 which provides the mobile operator to the authorisation and accounting systems.

Still referring to FIG. 5, requests from the e-mail client application 40 received at the gateway 16 via interface A are first processed by interface A processor 42 and expedited to a requested e-mail server 18 using interface B and under control of the connection management function 46. In this regard, each request received from the e-mail client 40 is self contained in that all the information necessary for completing the transaction, such as the user credentials (mailbox name and password), type of information requested and the like is contained within a single request. The connection management function 46 uses the information provided in the request in order to access e-mail related information which is stored on the e-mail server 18. Once all the e-mail related information requested is received from the e-mail server 18 via interface B (possibly through multiple transactions as described further hereinbelow) and compiled by the channel management function 46, the e-mail related information is returned to e-mail client application 40 in a single self contained response via interface A. Of note is that interface A is stateless, that is although the channel management function 46 retains information regarding the destination of a response for each request, subsequent request pairs from the same client are not related.

Note that, in a particular embodiment using HTTP to transmit requests for e-mail related information between the e-mail client application 40 and the gateway 16, Cookies can be taken advantage to store some of the information necessary for completing a transaction. As known in the art, an HTTP server, when returning an HTTP object to a HTTP client, may also send information which the client will store (referred to generally as a Cookie). Any future HTTP objects sent by the client may include a transmittal of the information from the HTTP client back to the HTTP server. In this regard, when the e-mail client application 40 initially transmits a request for e-mail related information to the gateway 16 using HTTP, the gateway 16 (which is also an HTTP server and can thus take advantage of Cookies) may return a Cookie in a subsequent response. In particular, as known in the art, certain e-mail servers
return a session ID which can be used for subsequent interactions with the e-mail server 18 once a connection between the gateway 16 and the e-mail server 18 has been opened via interface B. For subsequent e-mail related information requests between the e-mail client application 40 and the gateway 16, instead of resending the user credentials and other information which would otherwise be necessary for transacting with the e-mail server 18, the Cookie is attached to the HTTP object.

Still referring to FIG. 5, therefore as discussed briefly hereinabove and as will be described in more detail hereinbelow, interface A is designed to provide an interface between the wireless devices 12 and the gateway 16 illustratively using single self-contained request/response pairs 54, for example using HTTP objects. These request/response pairs 54 also allow for other advantages, for example piggybacking of multiple requests in a single self-contained pair. Indeed, both a request for the inbox view as well as a request for the list of folders may be combined in a single request transmitted to the gateway 16 by the client 40.

Conversely, interface B can be any interface supported by the various e-mail providers, namely those using such signalling protocols as IMAP, SMTP, POP3 and other common standardised or proprietary protocols, and use multiple transactions 56 in order to complete a single request 58, as common with such protocols. Necessarily, the implementation of the Interface B processor 44 is largely dependent on the particular e-mail service provider 20 the gateway 16 is requested to interact with.

As the gateway 16 is used to complete wireless e-mail transactions requested by an end user using a wireless device 12, the present e-mail system 10 provides a means for the mobile network operator to distinguish e-mail data traffic from other data traffic, such as for example data related to web browsing or the like. This provides for a number of advantages including billing and subscription capabilities which would otherwise be unavailable.

Referring back to FIG. 1A, the wireless e-mail system 10 of the present invention allows a wireless mobile device 12 to support an e-mail client application 40 for e-mail functions, with most of the processing offloaded to an external platform, such as the gateway 16, that is not significantly constrained by memory, processing capability or power supply (common restrictions in portable wireless devices as in 12). Of note is that in the illustrative embodiment of FIG. 1A, the gateway 16 is an extension of the mobile operator network 14.

Referring now to FIG. 1B, in an alternative illustrative embodiment of the wireless e-mail system, generally referred to using the reference numeral 10′, the e-mail gateways 162 and 163 are illustrated as extensions to e-mail servers 184 and 185 of service provider network 60 and corporate network 62 respectively. Referring back to FIG. 1A in addition to FIG. 1B, in both embodiments (10 and 10′), processing is substantially offloaded to the gateways 16, independent of their specific position within the e-mail systems 10 and 10′. However, as the gateways 162 and 163 are coupled to the respective e-mail servers of service provider network 60 and corporate network 62, the monitoring and billing features of the gateways 162 and 163 will be respectively interfaced with the service provider network 60 and the corporate network 62 instead of with the mobile operator network 14.

As discussed above, interface A is a request/response interface with the request originating from the e-mail client application 40. The e-mail client application 40 initiates a request via interface A using a format which allows it to retrieve the information it requires to be displayed in a single request/response pair. However, unlike standard e-mail protocols which require multiple transactions and significant processing on the part of the client to extract the required information, interface A allows for a single transaction (or request/response pair) 54 between the e-mail client application 40 and the gateway 16 for each request. As each request is self-contained, there is no need for user-specific information, such as filters, to be stored on the gateway 16. The system performs a transfer of a subset of the data as requested by the user using a single stateless request/response pair 54, illustratively using HTTP objects, for each of the transactions initiated by the e-mail client application 40. Consequently, the e-mail client application 40 is not required to maintain a persistent session with the e-mail server 18, or the gateway 16, in order to initiate subsequent mobile client transactions, as is required for example by IMAP or POP3.

Furthermore, in a particular implementation the e-mail client application 40 can be configured such that each time the e-mail client application 40 is launched it retrieves the most recent e-mail related information via interface A, and as a result the wireless mobile device 12 need not keep persistent storage of the user data (e-mail messages) in memory for extended periods of time. Subsequently, data can be fetched just-in-time for each user request. On the other hand, although no sessions are required between the e-mail client application 40 and the gateway 16 for communication purposes, a session may optionally be used to allow for additional security, for example use of HTTPS between the e-mail client application 40 and the gateway 16.

Transactions between client 40 and gateway 16 may be generally grouped into one of three categories: one for alerts and notifications (see Table 1 below), one for requests for e-mail related information retrieval (see Table 2 below) and the other for requests for sending or modifying e-mail related information (see Table 3 below). Furthermore, as discussed hereinabove, interface A also allows for the piggybacking of multiple requests in a single request/response pair. In practice, interface A may be implemented using an Extensible Mark up Language (XML) structure or SyncML, though other similar structures may also be used. Specific examples of such commands will be discussed further hereinbelow with reference to Tables 1, 2 and 3.

Referring now back to FIG. 5, as discussed briefly above, interface B is illustratively any interface supported by the various e-mail providers, namely using such protocols as IMAP, SMTP, POP3 and other common standardised or proprietary protocols. In other words, if a user seeks e-mail connectivity with an e-mail service provider using IMAP, the channel management function 46 within the gateway 16 will process the request provided through interface A such that interface B also uses IMAP as signalling protocols. Consequently, though communications between the e-mail client application 40 and the gateway 16 through interface A use single request/response pairs 54, communications between the gateway 16 and the various service providers 20 through interface B may include multiple transactions 56.

In Tables 1, 2 and 3, illustrative embodiments of primitives for communication between the e-mail client application 40 and the gateway 16 via interface A are shown. System primitives are relayed from the gateway 16 to the e-mail client application 40 and comprise primarily alerts as to the presence of new e-mail and services and the like (Table 1). This is typically information sent to the e-mail client application 40 without a specific request for the information being received from the e-mail client application 40. Client primitives are grouped into two categories: one for retrieval of e-mails and related content (Table 2), and the other for sending e-mails or modifying related content (Table 3). Each request results in a response (not shown). Necessarily, the content of Interface A may include other components not listed here, without departing from the general concept provided by the wireless e-mail system 10.

TABLE 1
System Primitives for Sending Alerts and Notifications

| | Main Content | |
|---|---|---|
| Primitive | of Message | Comments |
| Alert/Notification | New message | Used to notify users of a new |
| | count | message arrival |
| Alert/System | Text to display | Used to convey a system message to |
| Message | to end-user | end-user, such as the availability of |
| | | new services |

TABLE 2
Client Primitives for Retrieving Content

| Primitive | Main Record Filter | Main Field Filter | Comments |
|---|---|---|---|
| Get/Message Request | Message Identity | One or more of: | Use to retrieve an email |
| | | Attachment | message or multiple email |
| | | Full text | messages |
| | | Partial text | |
| | | (referenced by kB) | |
| | | (or any subfields from | |
| | | list directly below) | |
| Get/Mailbox View | Mailbox Identity | One or more of: | Use to retrieve a list of |
| | One of: | To | messages in a mailbox page |
| | Page Number | From | |
| | Number of Pages | Subject | |
| | | Date | |
| | | Size | |
| | | cc | |
| | | bcc | |
| | | /Read | |
| | | /Answered | |
| | | Attachment Flag | |
| | | Attachment Name(s) | |
| | | Partial Text | |
| Get/Account View | One of: | One or more of: | Used to retrieve a list of |
| | Full list | Folder Capabilities: | folders (mailboxes), and |
| | System list | Read/ | their capabilities |
| | | Write/Delete/Rename | |
| | | Total number of | |
| | | messages | |
| | | Total unread | |
| | | messages | |
| Get/Address | One of: | | Used to retrieve an address |
| | Full list | | |
| | Letter range (e.g. A-C) | | |
| | Search field | | |
| Get/ProfileView | | | Used to retrieve service- |
| | | | related information |

TABLE 3
Client Primitives for Sending and Modifying Content

| Primitive | Main Content of Message | Comments |
|---|---|---|
| Put/Send | Message Header and | Used to send new message. |
| | Content | |
| Put/Forward | Message Identity, Header | Used to forward a message |
| | and Content | |
| Put/Reply | Message Identity, Header | Used to reply to a message |
| | and Content | |
| Put/Notification Flag | On/Off Setting | Sent to server if an interface exists for e- |
| | | mail notification and the ability to turn e- |
| | | mail notification on/off is provided |
| Add/Message | Message Header and | Used to add a message to a mailbox (e.g. |
| | Content | store a draft e-mail) |
| Replace/Message | Message Identity and new | Used to move a message to a new |
| | mailbox name | mailbox |
| Delete/Message | Message Identity | Used to delete a message |
| Delete/Account View | Mailbox Identity | Used to delete a mailbox (folder) |
| Put/Account View | Mailbox Name | Used to create a new mailbox (folder) |
| Replace/Account View | Old and new mailbox names | Used to rename a mailbox (folder) |
| Replace/UpdateMsgFlag | Flags to be set | Used to mark e-mail as read/unread or |
| | | other flags |
| Replace/UpdateProfile | Profile entry | Allows to turn notification on/off |

As mentioned hereinabove, interface A also includes a response primitive, which occurs for each request generated by the e-mail client application 40. Furthermore, while a single request-response transaction 54 is required and used through interface A to communicate with the gateway 16, multiple transactions 56 through interface B may be used between the gateway 16 and the e-mail server 18 to gather all of the e-mail related information requested by the e-mail client application 40 without generating any latency and/or bandwidth concerns in the system 10. Additionally, and as also discussed hereinabove, in order to reduce data traffic the system primitives are typically piggybacked onto responses which generated are by the gateway 16 in response to each message request received from the e-mail client application 40.

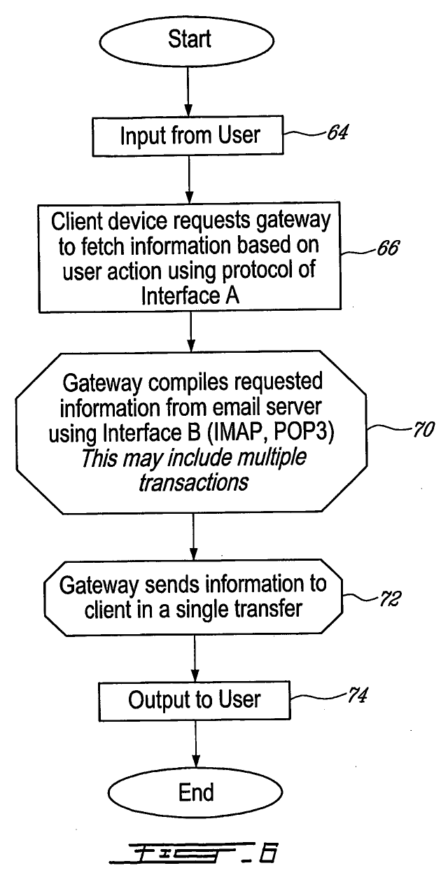

Referring now to FIGS. 1A, 1B and 6, and in accordance with an illustrative embodiment of the present invention, a high-level sequence of events of a single wireless e-mail transaction between an end user, an e-mail gateway 16 and an e-mail server 18 using the wireless e-mail system 10 is presented.

The wireless e-mail transaction starts with a user input at step 64, for example by requesting a particular e-mail for reading or retrieving a list of e-mails available on the server (see Table 2 for other examples of e-mail related information which can be retrieved).

In the following step 66, the e-mail client application 40 of the user's wireless device 12 requests the gateway 16 to either fetch, process, or send a specific set of information (including forward and reply requests) based on the user action of step 64 using the protocol of interface A. This request is sent. over the wireless network as a single self-contained request.

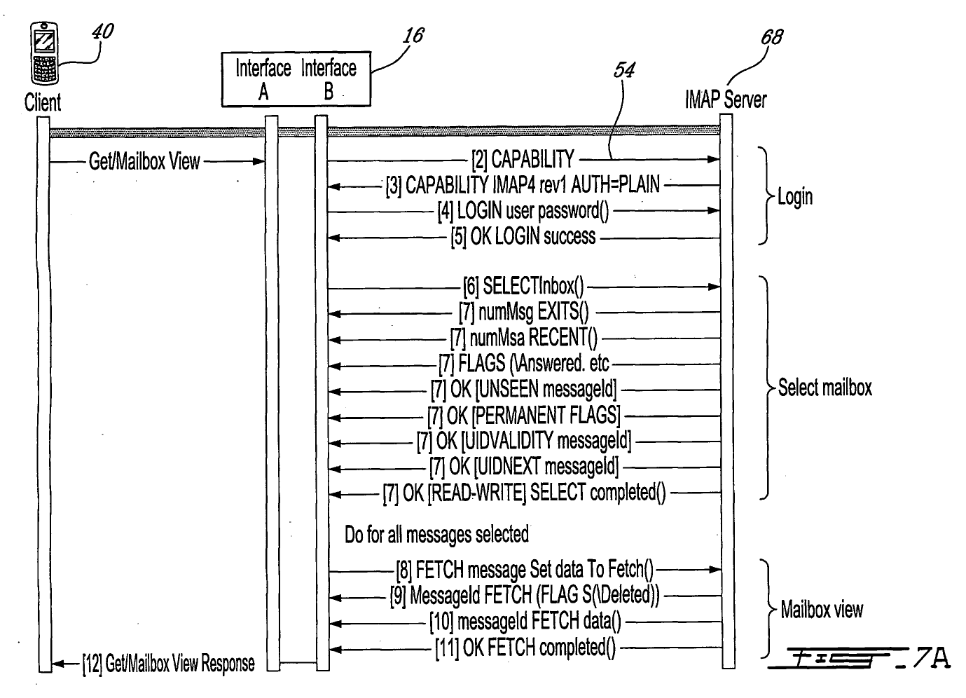

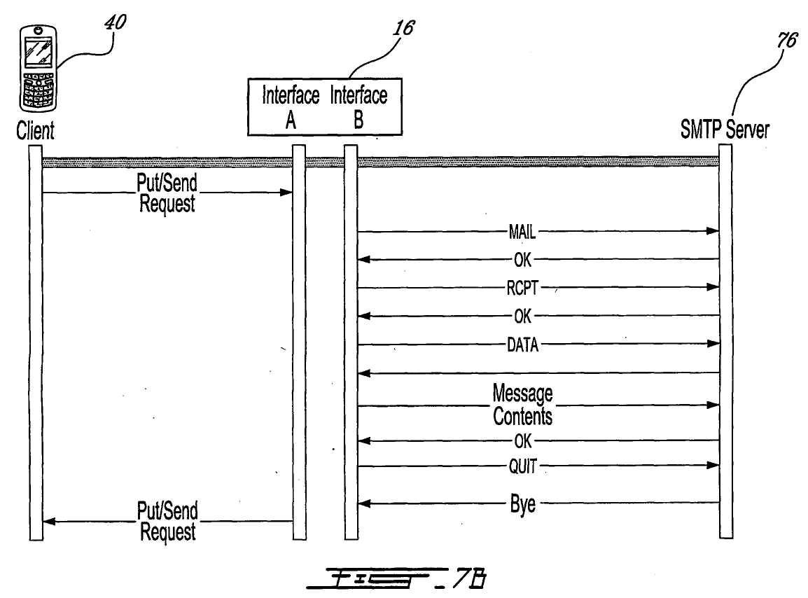

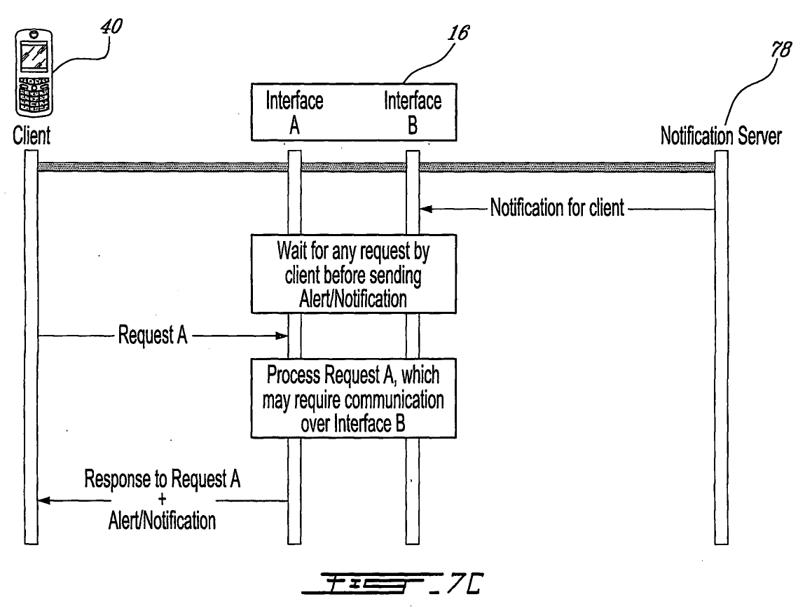

Referring now to FIG. 7A, if the user wishes to view the contents of a mail box illustratively on an IMAP server 68, the e-mail client application 40 forms a request using the Get/MailboxView primitive. Referring to Table 2 above, the Get/MailboxView primitive comprises a number of fields, including the mailbox name and whether a particular page should be downloaded, or a series of pages (allowing for caching of all pages on the e-mail client application 40, for example). The user may also, via the e-mail client application 40, request certain fields to be displayed such as the subject, date and the like. Of course, in many cases the fields which a user would like to download would be predefined in a preliminary configuration step.

Referring back to FIG. 6 in addition to FIG. 7A, in step 70, the gateway 16 communicates with the IMAP server 68 using a plurality of transactions as in 54 via interface B, illustratively by first logging onto the IMAP server 68 using the mail box name, downloading the contents of the mail box and then selecting all or a subset of the downloaded information. Again, communications in step 70 include multiple transactions 54. However, communications between gateway 16 and IMAP 68 server are typically over a broadband connection and therefore are not limited to bandwidth and latency issues experienced using wireless connections.

Referring back to FIG. 6, at step 72, after compiling the information downloaded into a suitable response to the request for e-mail related information by the e-mail client application 40, the gateway 16 sends the requested e-mail related information to the e-mail client application 40 in a single transfer, again using interface A over the wireless network.

Referring back to FIG. 7A, the information requested by the e-mail client application 40 using the Get/MailboxView primitive and retrieved from the IMAP server 68 is placed in a Get/MailboxViewResponse primitive and transferred via interface A to the e-mail client application 40.

Referring back to FIG. 6, at step 74, the requested e-mail related information is presented to the user by the e-mail client application 40.

Referring now to FIG. 7B and Table 3, in an alternative illustration, if the user wishes to send an e-mail message via a SMTP e-mail server 76, this is requested by the e-mail client application 40 using a single Put/SendRequest primitive. Again, upon reception of the Put/SendRequest primitive, the gateway 16 relays the e-mail message to the SMTP server 76 using a plurality of transactions and in accordance with the SMTP protocol.

Referring now to FIG. 7C, the gateway 16 may also receive notifications from a notification server 78, for example the arrival of a new e-mail at a particular e-mail server/mailbox. These notifications are illustratively transferred to the e-mail client application 40 by piggybacking them onto a subsequent response to a request received from the e-mail client application 40. Alternatively, such notifications (i.e. the system primitives as discussed hereinabove in reference to Table 1) and provided the gateway 16 and wireless mobile device 12 are suitably equipped may be transmitted to the e-mail client application 40 using SMS, WAP or the like.

As will now be apparent to a person of skill in the art, the wireless e-mail system 10 described herein allows for low cost thin e-mail client applications 40 to access e-mail via a wireless network. Additionally, the e-mail client applications 40 can be branded to reflect the look and feel of the e-mail service provider 20 the user has selected (for example Hotmail, Yahoo! Mail, AOL Mail or other such e-mail services). The e-mail client applications 40 requires only minimal resources, but can still provide a “PC-like” experience to the end user which is a significant improvement over that offered for example over WAP, which has until now been the typical approach to e-mail on low end and mid range devices.

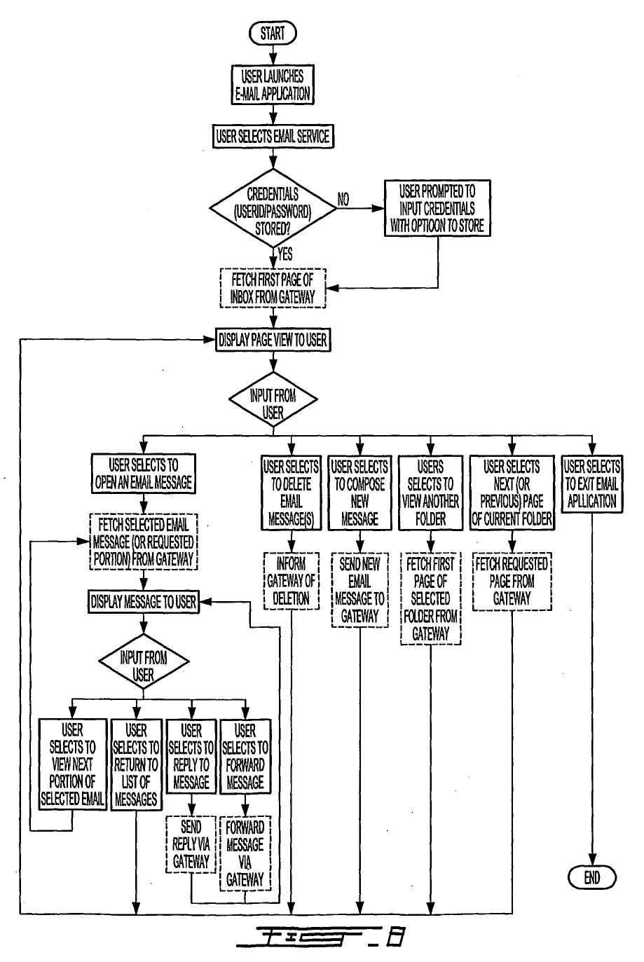

Referring now to FIG. 8, a flow-chart presenting a possible implementation of an e-mail client application 40 in accordance with an illustrative embodiment of the present invention is presented. Once the user has launched the e-mail application, selected the desired e-mail service and entered appropriate user ID/password information, primitives are sent to the gateway 16 requesting a first set of information (e.g. first page of the Inbox) for display to the user be fetched. The user may then select from a plurality of requests/options (e.g. open e-mail, delete e-mail, compose new e-mail, view folder, view next page, etc. . . . )which will be communicated to the gateway 16 in the form of request primitives and subsequently to the e-mail service provider 20. For each self-contained client request, the gateway 16 gathers the requested information or response from the service provider, and transfers the data to the mobile client in a single response for display to the user. Furthermore, a minimum of necessary data/information is downloaded to the client for each request. For example, when a user requests that an e-mail be forwarded, or that a reply includes the original e-mail, the gateway is capable of regenerating the original e-mail without requiring that the client download the full original e-mail over the wireless network.

Again, a thin client approach as illustrated herein allows offloading of processing and signalling to a broadband network that is relatively unconstrained by speed of transmission and other limitations such as memory or battery life. Consequently, the wireless e-mail system 10 reduces latencies and battery consumption as less signalling and processing are required of the mobile device 12. Furthermore, the use of a single just-in-time requesvresponse pair for each query makes much more efficient use of the wireless interface thus minimizing radio use and fragmentation. The resulting traffic flow is consistent with user requests, queries and general use of the system, making service costs transparent and understandable. Finally, the system 10 allows for monitoring and billing of the e-mail service by the mobile operator 14.

While this invention has been described with reference to the illustrative embodiments, this description is not intended to be construed to a limiting sense. Various modifications or combinations of the illustrative embodiments, as well as other embodiments of the invention, will be apparent to persons skilled in the art upon reference to the description. It is therefore intended that the described invention encompass any such modifications or embodiments.

We claim:

1. A wireless e-mail system comprising:
a wireless mobile device comprising an e-mail client;
an e-mail server;
a gateway;
a wireless network interconnecting said wireless mobile device and said gateway; and
a broadband network interconnecting said gateway and said e-mail server;
wherein when said client transmits a single self-contained request to said gateway via said wireless network to retrieve a set of e-mail related information from said e-mail server, said gateway retrieves at least said e-mail related information from said e-mail server via said broadband network using a plurality of transactions, compiles said retrieved information into a single self contained response and transmits said single response via said wireless network to said e-mail client.

2. The wireless e-mail system as in claim 1, wherein said self-contained request and said single response form a stateless request-response pair.

3. The wireless e-mail system as in claim 1, wherein said e-mail server is an IMAP server and said gateway further comprises an IMAP client application for communicating with said IMAP server.

4. The wireless e-mail system as in claim 1, wherein said e-mail server is a POP3 server and said gateway further comprises an POP3 client application for communicating with said POP3 server.

5. The wireless e-mail system as in claim 1, wherein said e-mail server is an SMTP compatible server and said gateway further comprises an SMTP client application for communicating with said SMTP compatible server.

6. The wireless e-mail system as in claim 1, wherein said gateway further comprises an application for monitoring e-mail traffic.

7. The wireless e-mail system as in claim 1, further comprising a mobile operator network, wherein said gateway is an extension of said mobile operator network.

8. The wireless e-mail system as in claim 1, wherein said single self-contained request and said single self contained response are transmitted using HTTP.

9. The wireless e-mail system as in claim 1, wherein said single self-contained request and said single self contained response are implemented using an XML structure.

10. A gateway interconnecting a wireless mobile device and an e-mail server, the wireless mobile device comprising an e-mail client and adapted for data communication with a wireless network, the e-mail server adapted for data communication with a broadband network, the gateway comprising:
a first stateless interface interconnected with the wireless network;
a second interface interconnected with the broadband network; and
a channel management function;
wherein when the e-mail client transmits a single self-contained request to said first interface via said wireless network to retrieve a set of e-mail related information from the e-mail server, said channel management function retrieves at least said e-mail related information from the e-mail server via said second interface and the broadband network using a plurality of transactions, compiles said retrieved information into a single self contained response and transmits said single response via said first interface and the mobile network to the e-mail client.

11. The gateway as in claim 10, wherein the e-mail server is an IMAP server, and said second interface is an IMAP interface.

12. The gateway as in claim 10, wherein the e-mail server is a POP3 server, and said second interface is a POP3 interface.

13. The gateway as in claim 10, further comprising an e-mail traffic monitoring application.

14. The gateway as in claim 10, wherein said single self-contained request and response are transmitted using HTTP and said first interface is an HTTP interface.

15. A method for retrieving e-mail related information from an e-mail server via a communications system comprising a wireless network and a broad band network, the method comprising the steps of:
in a client e-mail application on a wireless mobile device, forming a single request for the e-mail related information;
transmitting said single request to a gateway via the wireless network, said gateway retrieving at least the e-mail related information from the server via the broadband network using a plurality of transactions, wherein said gateway compiles said retrieved information into a single response;
transmitting said single response to said client application via said wireless network; and
in said client application, retrieving the e-mail related information from said response.

16. The method of claim 15, wherein the e-mail related information is located in a mailbox on the server, wherein said request comprises a mailbox ID and further wherein said retrieving step comprises logging onto the server using the mailbox ID and downloading the requested e-mail related information.

17. The method of claim 15, wherein the e-mail related information is located in a mailbox on the server, wherein said gateway periodically determines if new e-mail is available in said mailbox and further wherein if at least one new e-mail message is available in said mailbox, said gateway transmits a new e-mail message notification to said client application via said wireless network.

18. The method of claim 15, wherein the e-mail server is an IMAP server, said mailbox has a mailbox name and said periodic determining step comprises transmitting a SELECT command including said mailbox name to the server.

19. The method of claim 15, wherein the e-mail server is a POP3 server, said mailbox has a mailbox name and said periodic determining step comprises transmitting a UIDL command including said mailbox name to the server.

20. The method of claim 17, wherein said new e-mail message notification transmitting step comprises appending said new e-mail message notification to a subsequent single response.

21. The method of claim 17, wherein said wireless mobile device is an SMS compatible device and said new e-mail message notification transmitting step comprises transmitting said new e-mail message notification to said client e-mail application using SMS.

22. The method of claim 17, wherein said wireless mobile device is a WAP compatible device and said new e-mail message notification transmitting step comprises transmitting said new e-mail message notification to said client e-mail application using WAP.

23. The method of claim 17, wherein for each said new e-mail message said gateway retrieves at least a message sender and a message subject and appends said message sender and a message subject to a new e-mail list and wherein said new e-mail message notification comprises said new e-mail list.

24. The method of claim 17, wherein said gateway determines a quantity of new e-mail messages available in said mailbox and said new e-mail message notification comprises said quantity.

25. A method for retrieving e-mail related information from an e-mail server via a communications system comprising a wireless' network and a broad band network, the method comprising the steps of:
providing an e-mail gateway comprising a first stateless interface interconnected with the wireless network and a second interface interconnected with the broadband network;
in a client e-mail application on a wireless mobile device, transferring a single request for the e-mail related information to said first interface via the wireless network;
in said gateway:
receiving said request at said first interface;
retrieving at least the requested e-mail related information from the server via the broadband network using a plurality of transactions;
compiling said retrieved information into a single response; and
transmitting said single response to said client application via said first interface and said wireless network; and
in said client application, retrieving the e-mail related information from said response.

26. The method of claim 25, wherein the e-mail related information is located in a mailbox on the server, wherein said request comprises a mailbox ID and further wherein said retrieving step comprises logging onto the server using the mailbox ID and downloading the requested e-mail related information.

27. The method of claim 25, wherein the e-mail related information is located in a mailbox on the server, wherein said gateway periodically determines if new e-mail is available in said mailbox and further wherein if at least one new e-mail message is available in said mailbox, said gateway transmits a new e-mail message notification to said client application via said wireless network.

28. The method of claim 25, wherein the e-mail server is an IMAP server, said mailbox has a mailbox name and said periodically determining step comprises transmitting a SELECT command including said mailbox name to the server.

29. The method of claim 25, wherein the e-mail server is a POP3 server, said mailbox has a mailbox name and said periodically determining step comprises transmitting a UIDL command including said mailbox name to the server.

30. The method of claim 27, wherein said new e-mail message notification transmitting step comprises appending said new e-mail message notification to a subsequent single response.

31. The method of claim 27, wherein said wireless mobile device is an SMS compatible device and said new e-mail message notification transmitting step comprises transmitting said new e-mail message notification to said client e-mail application via SMS.

32. The method of claim 27, wherein said wireless mobile device is a WAP compatible device and said new e-mail message notification transmitting step comprises transmitting said new e-mail message notification to said client e-mail application using WAP.

33. The method of claim 27, wherein for each said new e-mail message said gateway retrieves at least a message sender and a message subject and appends said message sender and a message subject to a new e-mail list and wherein said new e-mail message notification comprises said new e-mail list.

34. The method of claim 27, wherein said gateway determines a quantity of new e-mail messages available in said mailbox and said new e-mail message notification comprises said quantity.

35. A method for logging e-mail data traffic between at least one wireless mobile device comprising a client e-mail application and an e-mail server interconnected by a wireless mobile operator network and a broadband network, the mobile network comprised of a wireless network and a ground network, the wireless network interconnecting the at least one wireless mobile device and the ground network and wherein the e-mail data traffic comprises at least one request for e-mail related information generated by the client e-mail application, the method comprising the steps of:
providing an e-mail gateway between the ground network and the broadband network;
for each request generated by the client e-mail application, transferring the request to said gateway via the wireless network; and
in said gateway:
receiving each request;
logging each received request;
retrieving at least the requested e-mail related information from the e-mail server;
compiling said retrieved information into a single response;
logging said single response; and
transmitting said single response to said client application via said wireless network.

36. The method of claim 35, wherein said request logging step comprises storing the number of bytes of each request.

37. The method of claim 35, wherein said response logging step comprises storing the number of bytes of each response.
